(19) United States
(12) Patent Application Publication
(10) Pub. No.: US 2016/0165230 A9
(43) Pub. Date: Jun. 9, 2016

(54) Color Component Checksum Computation in Video Coding

(71) Applicant: Texas Instruments Incorporated, Dallas, TX (US)

(72) Inventors: Ranga Ramanujam Srinivasan, Bangalore (IN); Mihir Narendra Mody, Bangalore (IN); Chaitanya Satish Ghone, Pune (IN)

(73) Assignee: Texas Instruments Incorporated, Dallas, TX (US)

(21) Appl. No.: 13/864,131

(22) Filed: Apr. 16, 2013

(30) Foreign Application Priority Data
Apr. 16, 2012 (IN) 1518/CHE/2012

(51) Int. Cl. H04N 7/26

(52) U.S. Cl. CPC H04N 19/00533

(57) ABSTRACT

Checksum computation for video coding is provided that breaks the dependency between the color components of a picture in the prior art. More specifically, rather than computing a single checksum for a picture as in the prior art, a separate checksum is computed for each color component. Computing a separate checksum for each color component enables parallel computation of the component checksums. Methods are provided for computing three separate checksums after a picture is decoded. Methods are also provided for computing three separate checksums on a largest coding unit basis, thus allowing the checksums for a picture to be computed as the picture is being decoded.

### CROSS-REFERENCE TO RELATED APPLICATIONS

This application claims benefit of Indian Provisional Patent Application Serial No. 1518/CHE/2012 filed Apr. 17, 2012, which is incorporated herein by reference in its entirety.

### BACKGROUND OF THE INVENTION

1. Field of the Invention

Embodiments of the present invention generally relate to color component checksum computation in video coding.

2. Description of the Related Art

Video compression, i.e., video coding, is an essential enabler for digital video products as it enables the storage and transmission of digital video. In general, video compression techniques apply prediction, transformation, quantization, and entropy coding to sequential blocks of pixels in a video sequence to compress, i.e., encode, the video sequence. Video decompression techniques generally perform the inverse of these operations in reverse order to decompress, i.e., decode, a compressed video sequence.

The Joint Collaborative Team on Video Coding (JCT-VC) of ITU-T WP3/16 and ISO/IEC JTC 1/SC 29/WG 11 is currently developing the next-generation video coding standard referred to as High Efficiency Video Coding (HEVC). HEVC is expected to provide around 50% improvement in coding efficiency over the current standard, H.264/AVC, as well as larger resolutions and higher frame rates. To address these requirements, HEVC utilizes larger block sizes then H.264/AVC. In HEVC, the largest coding unit (LCU) can be up to 64×64 in size, while in H.264/AVC, the macroblock size is fixed at 16×16.

Similar to previous coding standards, HEVC specifies the syntax and semantics supplemental enhancement information (SEI) messages that an encoder may use to convey information to a decoder. In general, the content of SEI messages does not affect the core decoding process; instead, such messages provide additional information to assist in the decoding process or to affect subsequent processing such as display.

In particular, HEVC specifies an SEI message, referred to as the picture hash SEI message, which conveys a checksum for a picture computed by the encoder and the particular algorithm used to compute the checksum to a decoder. A single checksum is provided for an entire picture and the checksum is computed across all three color components (Y, Cb, Cr) of the picture. This checksum may be used by the decoder for compliance testing, bit stream transmission or storage error detection, etc.

### SUMMARY

Embodiments of the present invention relate to methods, apparatus, and computer-readable media for color component checksum computation. In one aspect, a method is provided that includes decoding an encoded picture, and computing a checksum for each of a Y color component, a Cb color component, and a Cr color component of the decoded picture.

In one aspect, an apparatus is provided that includes means for decoding an encoded picture, and means for computing a checksum for each of a Y color component, a Cb color component, and a Cr color component of the decoded picture.

In one aspect, a non-transitory computer readable medium storing software instructions is provided. The software instructions, when executed by a processor, cause a method to be performed that includes decoding an encoded picture, and computing a checksum for each of a Y color component, a Cb color component, and a Cr color component of the decoded picture.

### BRIEF DESCRIPTION OF THE DRAWINGS

Particular embodiments will now be described, by way of example only, and with reference to the accompanying drawings:

FIG. 1 is a flow diagram of a prior art method for checksum computation for a decoded picture;

FIG. 2 is a block diagram of a digital system;

FIGS. 3A and 3B are block diagrams of a video encoder;

FIGS. 4A and 4B are block diagrams of a video decoder;

FIGS. 5-10 are flow diagrams of methods;

FIGS. 11A and 11B are an example; and

FIG. 12 is a block diagram of an illustrative digital system.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” may refer to a frame or a field of a frame. A frame is a complete image captured during a known time interval. For convenience of description, embodiments of the invention are described herein in reference to HEVC. One of ordinary skill in the art will understand that embodiments of the invention are not limited to HEVC.

In HEVC, a largest coding unit (LCU) is the base unit used for block-based coding. A picture is divided into non-overlapping LCUs. That is, an LCU plays a similar role in coding as the macroblock of H.264/AVC, but it may be larger, e.g., 32×32, 64×64, etc. An LCU may be partitioned into coding units (CU). A CU is a block of pixels within an LCU and the CUs within an LCU may be of different sizes. The partitioning is a recursive quadtree partitioning. The quadtree is split according to various criteria until a leaf is reached, which is referred to as the coding node or coding unit. The maximum hierarchical depth of the quadtree is determined by the size of the smallest CU (SCU) permitted. The coding node is the root node of two trees, a prediction tree and a transform tree. A prediction tree specifies the position and size of prediction units (PU) for a coding unit. A transform tree specifies the position and size of transform units (TU) for a coding unit. A transform unit may not be larger than a coding unit and the size of a transform unit may be, for example, 4×4, 8×8, 16×16, and 32×32. The sizes of the transforms units and prediction units for a CU are determined by the video encoder during prediction based on minimization of rate/distortion costs.

Various versions of HEVC are described in the following documents, which are incorporated by reference herein: T. Wiegand, et al., “WD3: Working Draft 3 of High-Efficiency Video Coding,” JCTVC-E603, Joint Collaborative Team on Video Coding (JCT-VC) of ITU-T SG16 WP3 and ISO/IEC JTC1/SC29/WG11, Geneva, CH, Mar. 16-23, 2011 (“WD3”), B. Bross, et al., “WD4: Working Draft 4 of High-Efficiency Video Coding,” JCTVC-F803_d6, Joint Collaborative Team on Video Coding (JCT-VC) of ITU-T SG16 WP3 and ISO/IEC JTC1/SC29/WG11, Torino, IT, Jul. 14-22, 2011 (“WD4”), B. Bross. et al., “WD5: Working Draft 5 of High-Efficiency Video Coding,” JCTVC-G1103_d9, Joint Collaborative Team on Video Coding (JCT-VC) of ITU-T SG16 WP3 and ISO/IEC JTC1/SC29/WG11, Geneva, CH, Nov. 21-30, 2011 (“WD5”), B. Bross, et al., “High Efficiency Video Coding (HEVC) Text Specification Draft 6,” JCTVC-H1003, Joint Collaborative Team on Video Coding (JCT-VC) of ITU-T SG16 WP3 and ISO/IEC JTC1/SC29/WG1, Geneva, CH, Nov. 21-30, 2011 (“HEVC Draft 6”), B. Bross, et al., “High Efficiency Video Coding (HEVC) Text Specification Draft 7,” JCTVC-11003_d0, Joint Collaborative Team on Video Coding (JCT-VC) of ITU-T SG16 WP3 and ISO/IEC JTC1/SC29/WG1, Geneva, CH, April 17-May 7, 2012 (“HEVC Draft 7”), B. Bross, et al., “High Efficiency Video Coding (HEVC) Text Specification Draft 8,” JCTVC-J1003_d7, Joint Collaborative Team on Video Coding (JCT-VC) of ITU-T SG16 WP3 and ISO/IEC JTC1/SC29/WG1, Stockholm, SE, Jul. 11-20, 2012 (“HEVC Draft 8”), and B. Bross, et al., “High Efficiency Video Coding (HEVC) Text Specification Draft 9,” JCTVC-K1003_v7, Joint Collaborative Team on Video Coding (JCT-VC) of ITU-T SG16 WP3 and ISO/IEC JTC1/SC29/WG1, Shanghai, CN, Oct. 10-19, 2012 (“HEVC Draft 9”).

Some aspects of this disclosure have been presented to the JCT-VC in R. Srinivasan, et al., “LCU Based Input Order Scanning for HASH SEI Message”, JCTVC-10245, Joint Collaborative Team on Video Coding (JCT-VC) of ITU-T SG16 WP3 and ISO/IEC JTC1/SC29/WG11, Geneva, Switzerland, Apr. 27-May 12, 2012, which is incorporated by reference herein in its entirety.

As previously discussed, HEVC specifies a picture hash SEI message that conveys a checksum for a picture and the algorithm used to compute the checksum to a decoder. Table 1 shows the syntax for this SEI message as specified in HEVC Draft 6. Hash_type is an indicator of the particular algorithm used to compute the checksum. Two different algorithms, referred to as picture_md5 and picture_crc are allowed in this version of HEVC. Picture_md5 refers to the industry recognized MD5 Message Digest algorithm as described in RFC1321 (R. Rivest, “The MD5 Message-Digest Algorithm”, Request for Comments: 1321, Network Working Group, Internet Engineering Task Force (IETF), April 1992). Picture_crc refers to the cyclic redundancy check (CRC) algorithm described in “Video Back-Channel Messages for Conveyance of Status Information and Requests from a Video Receive to a Video Sender”, Series H: Audiovisual and Multimedia Systems, ITU-T Recommendation H.271, Telecommunication Standardization Sector of International Telecommunication Union, pp. 1-14, May 2006.

TABLE 1

```
Decoded_picture_hash( payloadSize ) {
  hash_type
  if( hash_type = = 0 )
    for( i = 0; i < 16; i++)
      picture_md5[ i ]
  else if( hash_type = = 1 )
    picture_crc
}
```

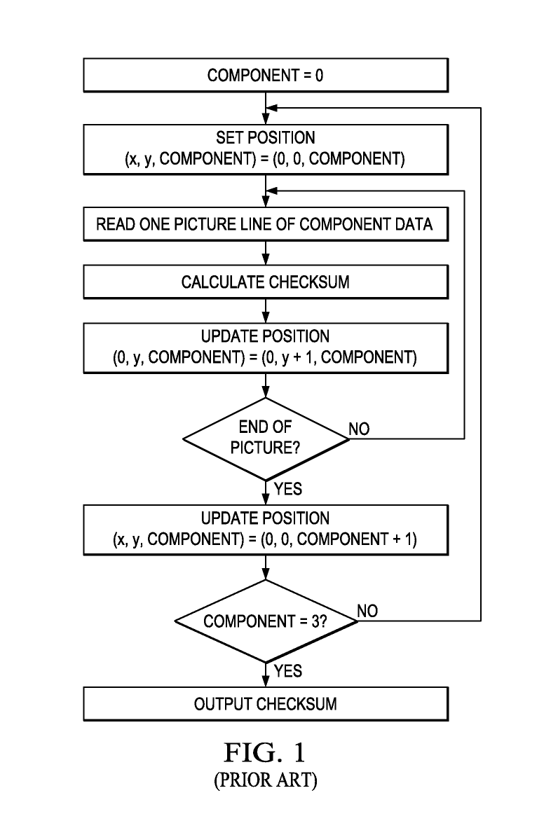

As currently defined in HEVC Draft 6, a single checksum is computed for a picture across all three color components (Y, Cb, Cr) of the picture. FIG. 1 is a flow diagram illustrating the prior art method for computing a picture checksum. The checksum is computed on the decoded picture in the encoder and in the decoder. This computation requires scanning lines of each color component of the picture in raster scan order, thus creating a sequential dependency in the computation. In addition, computation of the checksum in this manner results in increased memory bandwidth.

Embodiments of the invention provide for checksum computation that breaks the dependency between the color components. More specifically, rather than computing a single checksum for a picture as in the prior art, a separate checksum is computed for each color component. Computing a separate checksum for each color component enables parallel computation of the component checksums. In some embodiments, the three separate checksums are computed after the picture is decoded. In some embodiments, the three separate checksums are computed using an LCU-based method that allows the checksums to be computed as the picture is being decoded.

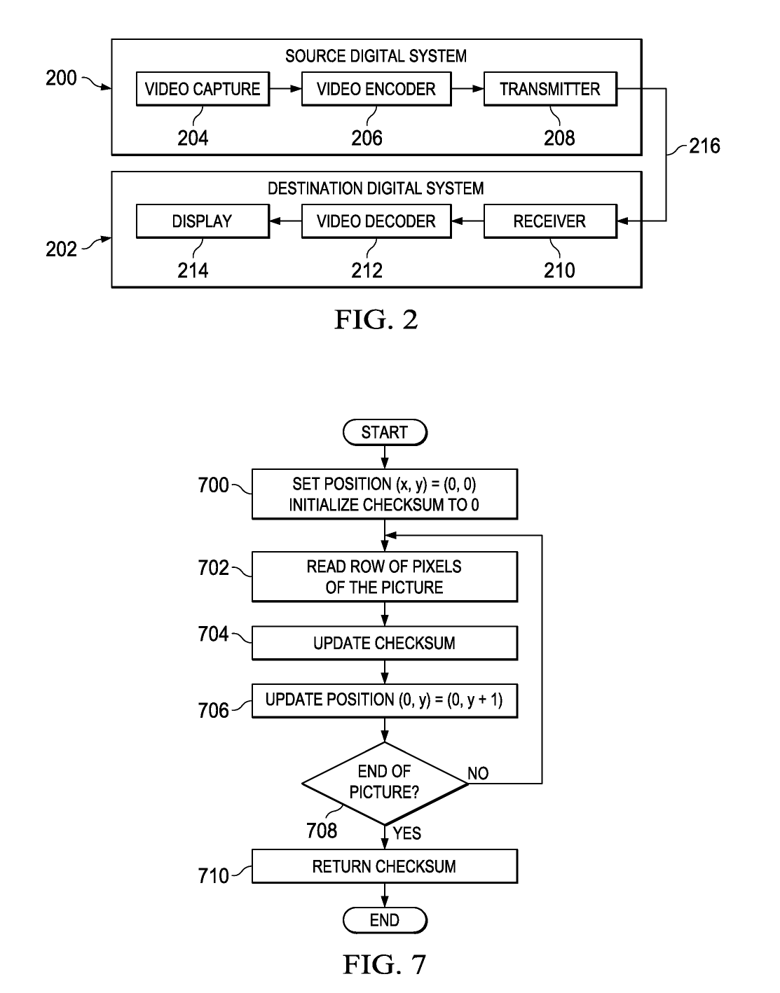

FIG. 2 shows a block diagram of a digital system that includes a source digital system 200 that transmits encoded video sequences to a destination digital system 202 via a communication channel 216. The source digital system 200 includes a video capture component 204, a video encoder component 206, and a transmitter component 208. The video capture component 204 is configured to provide a video sequence to be encoded by the video encoder component 206. The video capture component 204 may be, for example, a video camera, a video archive, or a video feed from a video content provider. In some embodiments, the video capture component 204 may generate computer graphics as the video sequence, or a combination of live video, archived video, and/or computer-generated video.

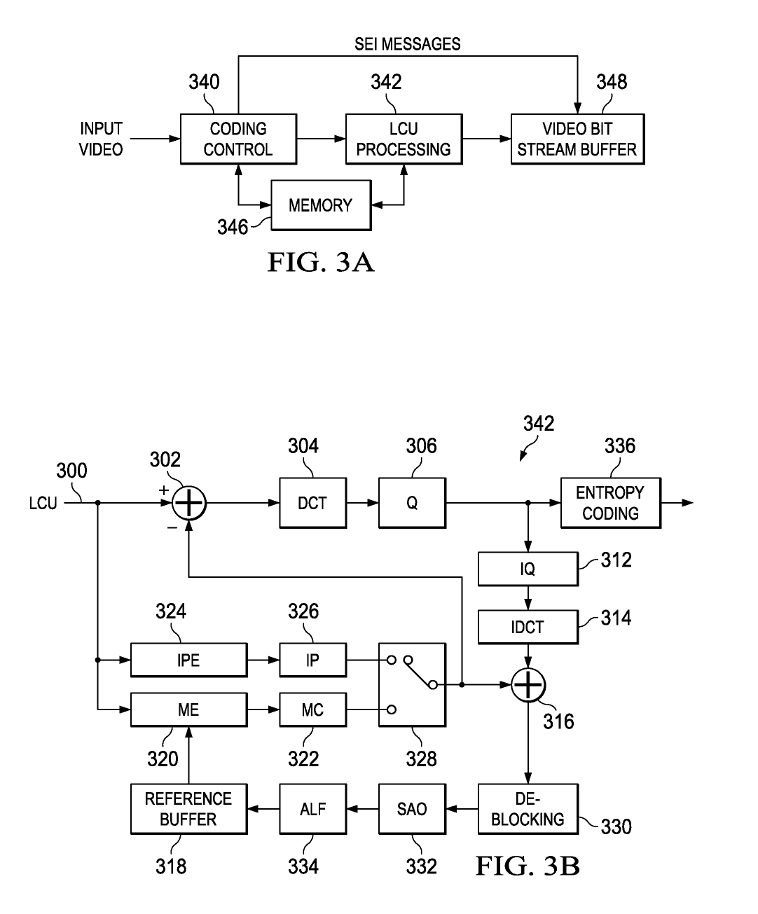

The video encoder component 206 receives a video sequence from the video capture component 204 and encodes it for transmission by the transmitter component 208. The video encoder component 206 receives the video sequence from the video capture component 204 as a sequence of pictures, divides the pictures into largest coding units (LCUs), and encodes the video data in the LCUs. The video encoder component 206 may be configured to compute checksums for reconstructed (decoded) pictures and transmit the checksums in hash SEI messages during the encoding process as described herein. An embodiment of the video encoder component 206 is described in more detail herein in reference to FIGS. 3A and 3B.

The transmitter component 208 transmits the encoded video data to the destination digital system 202 via the communication channel 216. The communication channel 216 may be any communication medium, or combination of communication media suitable for transmission of the encoded video sequence, such as, for example, wired or wireless communication media, a local area network, or a wide area network.

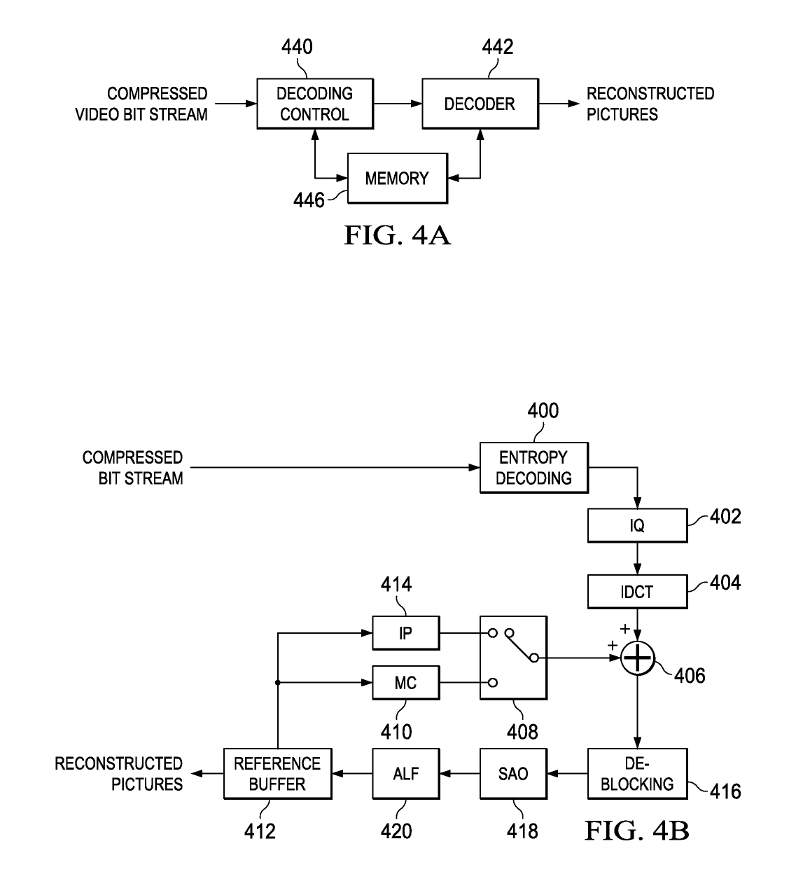

The destination digital system 202 includes a receiver component 210, a video decoder component 212 and a display component 214. The receiver component 210 receives the encoded video data from the source digital system 200 via the communication channel 216 and provides the encoded video data to the video decoder component 212 for decoding. The video decoder component 212 reverses the encoding process performed by the video encoder component 206 to reconstruct the LCUs of the video sequence. The video decoder component 212 may be configured to compute checksums for decoded pictures and compare the checksums to corresponding checksums received in hash SEI messages during the decoding process as described herein. An embodiment of the video decoder component 212 is described in more detail below in reference to FIGS. 4A and 4B.

The reconstructed video sequence is displayed on the display component 214. The display component 214 may be any suitable display device such as, for example, a plasma display, a liquid crystal display (LCD), a light emitting diode (LED) display, etc.

In some embodiments, the source digital system 200 may also include a receiver component and a video decoder component and/or the destination digital system 202 may include a transmitter component and a video encoder component for transmission of video sequences both directions for video streaming, video broadcasting, and video telephony. Further, the video encoder component 206 and the video decoder component 212 may perform encoding and decoding in accordance with one or more video compression standards. The video encoder component 206 and the video decoder component 212 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIGS. 3A and 3B show block diagrams of an example video encoder, e.g., the video encoder component of FIG. 2, with functionality to compute checksums for pictures and to encode hash SEI messages including the checksums in the compressed video bit stream. FIG. 3A shows a high level block diagram of the video encoder and FIG. 3B shows a block diagram of the LCU processing component 342 of the video encoder. As shown in FIG. 3A, the video encoder includes a coding control component 340, an LCU processing component 342, a memory 346, and a compressed video bit stream buffer 348. The memory 346 may be internal (on-chip) memory, external (off-chip) memory, or a combination thereof. The memory 346 may be used to communicate information between the various components of the video encoder. The video bit stream buffer 348 stores the compressed video bit stream generated by the encoder while it awaits transmission or storage.

An input digital video sequence is provided to the coding control component 340, e.g., from a video capture component 204 (see FIG. 2). The coding control component 340 sequences the various operations of the video encoder, i.e., the coding control component 340 runs the main control loop for video encoding. For example, the coding control component 340 performs processing on the input video sequence that is to be done at the picture level, such as determining the coding type (I, P, or B) of a picture based on a high level coding structure, e.g., IPPP, IBBP, hierarchical-B, and dividing a picture into LCUs for further processing.

In addition, for pipelined architectures in which multiple LCUs may be processed concurrently in different components of the LCU processing component 342, the coding control component controls the processing of the LCUs by various components of the LCU processing component 342 in a pipeline fashion. For example, in many embedded systems supporting video processing, there may be one master processor and one or more slave processing modules, e.g., hardware accelerators. The master processor operates as the coding control component and runs the main control loop for video encoding, and the slave processing modules are employed to off load certain compute-intensive tasks of video encoding such as motion estimation, motion compensation, intra prediction mode estimation, transformation and quantization, entropy coding, and loop filtering. The slave processing modules are controlled in a pipeline fashion by the master processor such that the slave processing modules operate on different LCUs of a picture at any given time. That is, the slave processing modules are executed in parallel, each processing its respective LCU while data movement from one processor to another is serial.

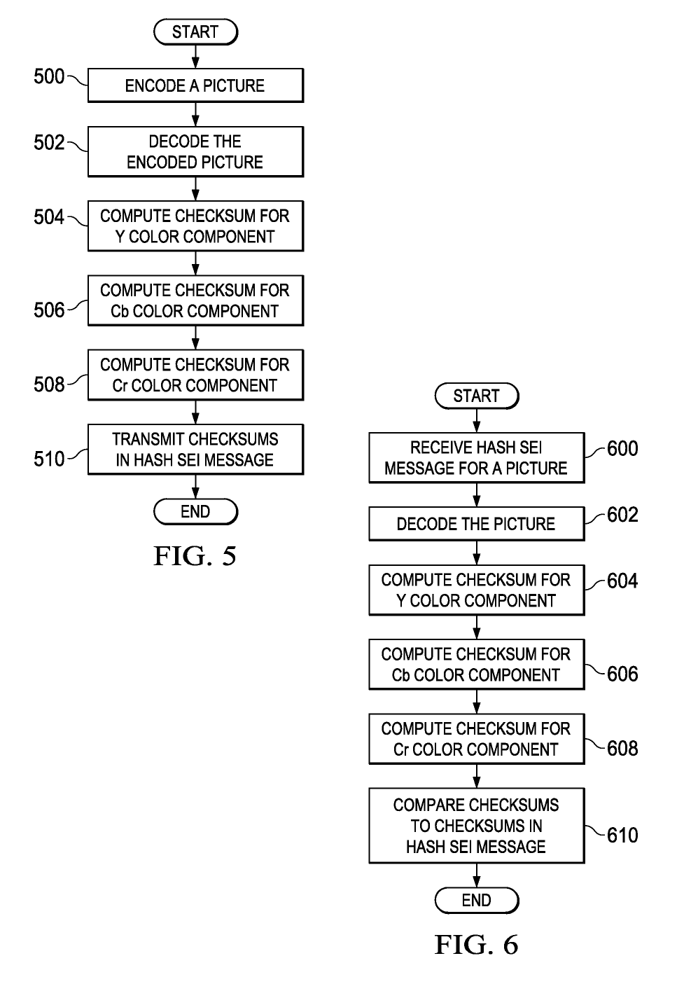

The coding control component 340 includes functionality to perform checksum computation for each encoded picture and to generate hash SEI messages with the computed checksums for each encoded picture that are included in the compressed bit stream. Methods for checksum computation and hash SEI message generation that may be performed by embodiments of the coding control component 340 are described herein in reference to FIGS. 5, 7, 8, and 10.

FIG. 3B is a block diagram of the LCU processing component 342. The LCU processing component 342 receives LCUs 300 of the input video sequence from the coding control component and encodes the LCUs 300 under the control of the coding control component to generate the compressed video stream. The LCUs 300 in each picture are processed in row order. The LCUs 300 from the coding control component are provided as one input of a motion estimation component (ME) 320, as one input of an intra-prediction estimation component (IPE) 324, and to a positive input of a combiner 302 (e.g., adder or subtractor or the like). Further, although not specifically shown, the prediction mode of each picture as selected by the coding control component is provided to a mode decision component 328 and the entropy coding component 336.

The storage component 318 provides reference data to the motion estimation component 320 and to the motion compensation component 322. The reference data may include one or more previously encoded and decoded pictures, i.e., reference pictures.

The motion estimation component 320 provides motion data information to the motion compensation component 322 and the entropy coding component 336. More specifically, the motion estimation component 320 performs tests on CUs in an LCU based on multiple inter-prediction modes (e.g., skip mode, merge mode, and normal or direct inter-prediction), PU sizes, and TU sizes using reference picture data from storage 318 to choose the best CU partitioning, PU/TU partitioning, inter-prediction modes, motion vectors, etc. based on coding cost, e.g., a rate distortion coding cost. To perform the tests, the motion estimation component 320 may divide an LCU into CUs according to the maximum hierarchical depth of the quadtree, and divide each CU into PUs according to the unit sizes of the inter-prediction modes and into TUs according to the transform unit sizes, and calculate the coding costs for each PU size, prediction mode, and transform unit size for each CU. The motion estimation component 320 provides the motion vector (MV) or vectors and the prediction mode for each PU in the selected CU partitioning to the motion compensation component (MC) 322.

The motion compensation component 322 receives the selected inter-prediction mode and mode-related information from the motion estimation component 320 and generates the inter-predicted CUs. The inter-predicted CUs are provided to the mode decision component 328 along with the selected inter-prediction modes for the inter-predicted PUs and corresponding TU sizes for the selected CU/PU/TU partitioning. The coding costs of the inter-predicted CUs are also provided to the mode decision component 328.

The intra-prediction estimation component 324 (IPE) performs intra-prediction estimation in which tests on CUs in an LCU based on multiple intra-prediction modes, PU sizes, and TU sizes are performed using reconstructed data from previously encoded neighboring CUs stored in a buffer (not shown) to choose the best CU partitioning, PU/TU partitioning, and intra-prediction modes based on coding cost, e.g., a rate distortion coding cost. To perform the tests, the intra-prediction estimation component 324 may divide an LCU into CUs according to the maximum hierarchical depth of the quadtree, and divide each CU into PUs according to the unit sizes of the intra-prediction modes and into TUs according to the transform unit sizes, and calculate the coding costs for each PU size, prediction mode, and transform unit size for each PU. The intra-prediction estimation component 324 provides the selected intra-prediction modes for the PUs, and the corresponding TU sizes for the selected CU partitioning to the intra-prediction component (IP) 326. The coding costs of the intra-predicted CUs are also provided to the intra-prediction component 326.

The intra-prediction component 326 (IP) receives intra-prediction information, e.g., the selected mode or modes for the PU(s), the PU size, etc., from the intra-prediction estimation component 324 and generates the intra-predicted CUs. The intra-predicted CUs are provided to the mode decision component 328 along with the selected intra-prediction modes for the intra-predicted PUs and corresponding TU sizes for the selected CU/PU/TU partitioning. The coding costs of the intra-predicted CUs are also provided to the mode decision component 328.

The mode decision component 328 selects between intra-prediction of a CU and inter-prediction of a CU based on the intra-prediction coding cost of the CU from the intra-prediction component 326, the inter-prediction coding cost of the CU from the motion compensation component 322, and the picture prediction mode provided by the coding control component. Based on the decision as to whether a CU is to be intra- or inter-coded, the intra-predicted PUs or inter-predicted PUs are selected. The selected CU/PU/TU partitioning with corresponding modes and other mode related prediction data (if any) such as motion vector(s) and reference picture index (indices), are provided to the entropy coding component 336.

The output of the mode decision component 328, i.e., the predicted PUs, is provided to a negative input of the combiner 302 and to the combiner 338. The associated transform unit size is also provided to the transform component 304. The combiner 302 subtracts a predicted PU from the original PU. Each resulting residual PU is a set of pixel difference values that quantify differences between pixel values of the original PU and the predicted PU. The residual blocks of all the PUs of a CU form a residual CU for further processing.

The transform component 304 performs block transforms on the residual CUs to convert the residual pixel values to transform coefficients and provides the transform coefficients to a quantize component 306. More specifically, the transform component 304 receives the transform unit sizes for the residual CU and applies transforms of the specified sizes to the CU to generate transform coefficients. Further, the quantize component 306 quantizes the transform coefficients based on quantization parameters (QPs) and quantization matrices provided by the coding control component and the transform sizes and provides the quantized transform coefficients to the entropy coding component 336 for coding in the bit stream.

The entropy coding component 336 entropy encodes the relevant data, i.e., syntax elements, output by the various encoding components and the coding control component using context-adaptive binary arithmetic coding (CABAC) to generate the compressed video bit stream. Among the syntax elements that are encoded are picture parameter sets, flags indicating the CU/PU/TU partitioning of an LCU, the prediction modes for the CUs, and the quantized transform coefficients for the CUs. The entropy coding component 336 also codes relevant data from the in-loop filters (described below).

The LCU processing includes an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent pictures and to compute checksums to be included in hash SEI message in the compressed bit stream.

The quantized transform coefficients for each CU are provided to an inverse quantize component (IQ) 312, which outputs a reconstructed version of the transform result from the transform component 304. The dequantized transform coefficients are provided to the inverse transform component (IDCT) 314, which outputs estimated residual information representing a reconstructed version of a residual CU. The inverse transform component 314 receives the transform unit size used to generate the transform coefficients and applies inverse transform(s) of the specified size to the transform coefficients to reconstruct the residual values. The reconstructed residual CU is provided to the combiner 338.

The combiner 338 adds the original predicted CU to the residual CU to generate a reconstructed CU, which becomes part of reconstructed picture data. The reconstructed picture data is stored in a buffer (not shown) for use by the intra-prediction estimation component 324.

Various in-loop filters may be applied to the reconstructed picture data to improve the quality of the reference picture data used for encoding/decoding of subsequent pictures. The in-loop filters may include a deblocking filter component 330, a sample adaptive offset filter (SAO) component 332, and an adaptive loop filter (ALF) component 334. The in-loop filters 330, 332, 334 are applied to each reconstructed LCU in the picture and the final filtered reference picture data is provided to the storage component 318. In some embodiments, the ALF filter component may not be present.

FIGS. 4A and 4B show block diagrams of an example video decoder, e.g., the video decoder component of FIG. 2, with functionality to decode hash SEI messages from compressed video bit stream and to compute checksums for decoded pictures according to the checksum algorithm signaled in the hash SEI messages. FIG. 4A shows a high level block diagram of the video decoder and FIG. 4B shows a block diagram of the decoding component 442 of the video decoder. In general, the video decoder operates to reverse the encoding operations, i.e., entropy coding, quantization, transformation, and prediction, performed by the video encoder of FIGS. 3A and 3B to regenerate the pictures of the original video sequence. In view of the above description of a video encoder, one of ordinary skill in the art will understand the functionality of components of the video decoder without need for detailed explanation.

Referring now to FIG. 4A, the video decoder includes a decoding control component 440, a decoding component 442, and a memory 446. The memory 446 may be internal (on-chip) memory, external (off-chip) memory, or a combination thereof. The memory 446 may be used to communicate information between the various components of the video decoder. An input compressed video bit stream is provided to the decoding control component 440, e.g., from a source digital system 200 (see FIG. 2). The decoding control component 440 sequences the various operations of the video decoder, i.e., the decoding control component 440 runs the main control loop for video decoding.

For pipelined architectures in which multiple LCUs may be processed concurrently in different components of the decoding component 442, the decoding control component 440 controls the processing of the LCUs by various components of the decoding component 442 in a pipeline fashion. For example, in many embedded systems supporting video processing, there may be one master processor and one or more slave processing modules, e.g., hardware accelerators. The master processor operates as the decoding control component and runs the main control loop for video decoding, and the slave processing modules are employed to off load certain compute-intensive tasks of video decoding such as motion compensation, inverse transformation and inverse quantization, entropy decoding, and loop filtering. The slave processing modules are controlled in a pipeline fashion by the master processor such that the slave processing modules operate on different LCUs of a picture at any given time. That is, the slave processing modules are executed in parallel, each processing its respective LCU while data movement from one processor to another is serial.

The decoding control component 440 includes functionality to receive hash SEI messages from the compressed video bit stream, to perform checksum computation for each decoded picture according to the checksum algorithms specified in the hash SEI messages, to compare the computed checksums to the checksums in the hash SEI messages, and to take appropriate action when the checksums do not match. Methods for checksum computation and hash SEI message handling that may be performed by embodiments of the decoding control component 440 are described herein in reference to FIGS. 6, 7, 9, and 10.

FIG. 4B shows a block diagram of the decoding component 442. The decoding component 442. The decoding component 442 receives a compressed bit stream from the decoding control component 440 and decodes the encoded pictures. The entropy decoding component 400 receives the entropy encoded (compressed) video bit stream and reverses the entropy encoding using CABAC decoding to recover the encoded syntax elements, e.g., CU, PU, and TU structures of LCUs, quantized transform coefficients for CUs, motion vectors, prediction modes, etc. The decoded syntax elements are passed to the various components of the decoding component 442 as needed. For example, decoded prediction modes are provided to the intra-prediction component (IP) 414 or motion compensation component (MC) 410. If the decoded prediction mode is an inter-prediction mode, the entropy decoder 400 reconstructs the motion vector(s) as needed and provides the motion vector(s) to the motion compensation component 410.

The inverse quantize component (IQ) 402 de-quantizes the quantized transform coefficients of the CUs. The inverse transform component 404 transforms the frequency domain data from the inverse quantize component 402 back to the residual CUs. That is, the inverse transform component 404 applies an inverse unit transform, i.e., the inverse of the unit transform used for encoding, to the de-quantized residual coefficients to produce reconstructed residual values of the CUs.

A residual CU supplies one input of the addition component 406. The other input of the addition component 406 comes from the mode switch 408. When an inter-prediction mode is signaled in the encoded video stream, the mode switch 408 selects predicted PUs from the motion compensation component 410 and when an intra-prediction mode is signaled, the mode switch selects predicted PUs from the intra-prediction component 414.

The motion compensation component 410 receives reference data from the storage component 412 and applies the motion compensation computed by the encoder and transmitted in the encoded video bit stream to the reference data to generate a predicted PU. That is, the motion compensation component 410 uses the motion vector(s) from the entropy decoder 400 and the reference data to generate a predicted PU.

The intra-prediction component 414 receives reconstructed samples from previously reconstructed PUs of a current picture from the storage component 412 and performs the intra-prediction computed by the encoder as signaled by an intra-prediction mode transmitted in the encoded video bit stream using the reconstructed samples as needed to generate a predicted PU.

The addition component 406 generates a reconstructed CU by adding the predicted PUs selected by the mode switch 408 and the residual CU. The output of the addition component 406, i.e., the reconstructed CUs, is stored in the storage component 412 for use by the intra-prediction component 414.

In-loop filters may be applied to reconstructed picture data to improve the quality of the decoded pictures and the quality of the reference picture data used for decoding of subsequent pictures. The applied in-loop filters are the same as those of the encoder, i.e., a deblocking filter 416, a sample adaptive offset filter (SAO) 418, and an adaptive loop filter (ALF) 420. In some embodiments, the ALF component 420 may not be present. The in-loop filters may be applied on an LCU-by-LCU basis and the final filtered reference picture data is provided to the storage component 412.

FIGS. 5, 6, and 7 are flow diagrams for, respectively, a method for checksum computation and hash SEI message generation for a picture that may be performed in a video encoder, e.g., the video encoder of FIGS. 4A and 4B, a method for hash SEI message decoding and checksum computation for a picture that may be performed in a video decoder, e.g., the video decoder of FIGS. 5A and 5B, and a method for checksum computation used by the methods of FIGS. 5 and 6.

Referring first to the method of FIG. 5, a picture of a video sequence is encoded 500 into a video bit stream. The picture is then reconstructed (decoded) 502 to generate a reference picture for use in encoding one or more future pictures in the video sequence. Decoding of the picture may include applying any in-loop filters that will also be used by a decoder. Checksums are then computed 504, 506, 508 for each color component (Y, Cb, Cr) of the decoded picture. Computation of a checksum for a color component is performed as per the method of FIG. 7. Note that because the checksums are computed separately for each color component, these computations may be performed in parallel in some embodiments. The computed checksums are then transmitted 510 in the compressed bit stream in a hash SEI message corresponding to the picture. Table 2 shows example syntax for a hash SEI message conveying the three separate checksums. The variable comp refers to the three color components Y, Cb, and Cr. The particular syntax is shown is derived from the original message syntax in HEVC Draft 6. Different suitable syntax may be used.

TABLE 2

```
Decoded_picture_hash( payloadSize ) {
  hash_type
  if( hash_type = = 0 )
    for(comp=0; comp<3; comp++)
      for( i = 0; i < 16; i++)
        picture_md5[comp][ i ]
  else if( hash_type = = 1 )
    for(comp=0; comp<3; comp++)
      picture_crc[comp]
}
```

Referring now to the method of FIG. 6, a hash SEI message for a picture is received 600. The checksum algorithm to be used and the color component checksums computed by the encoder for the picture are determined from this message. The picture is decoded 602 from the video bit stream. Decoding of the picture includes applying any in-loop filters that were used by the encoder. Checksums are then computed 604, 606, 608 for each color component (Y, Cb, Cr) of the decoded picture using the particular checksum algorithm specified in the hash SEI message. Computation of a checksum for a color component is performed as per the method of FIG. 7. Note that because the checksums are computed separately for each color component, these computations may be performed in parallel in some embodiments. The computed checksums are then compared 610 to the corresponding checksums from the hash SEI message. If the checksums are the same, normal processing continues. Actions taken if checksums are not the same are application dependent. For example, for an error prone transmission network, loss of bits or packets may be assumed and an error concealment process initiated. In another example, in video surveillance, camera tampering may be assumed and a security alert signaled.

As previously mentioned, FIG. 7 is a flow diagram of a method for checksum computation for a color component of a decoded picture that is used by the methods of FIGS. 5 and 6. This method is performed after a picture has been decoded and is performed for each of the three color components Y, Cb, and Cr. This method assumes that the checksum algorithm to be used has been previously selected. Initially, the row position (x,y) in the decoded picture is initialized 700 to (0,0) (the top row of the picture) and the checksum is initialized 700 to 0. A row of pixels of the picture corresponding to the position is read 702 and the checksum is updated 704 according to color component values of the pixels in the row. The position is then updated 706 to the next row. This checksum computation process 702-706 is repeated until the end of the picture 708 is reached. The checksum for the color component is then returned 710.

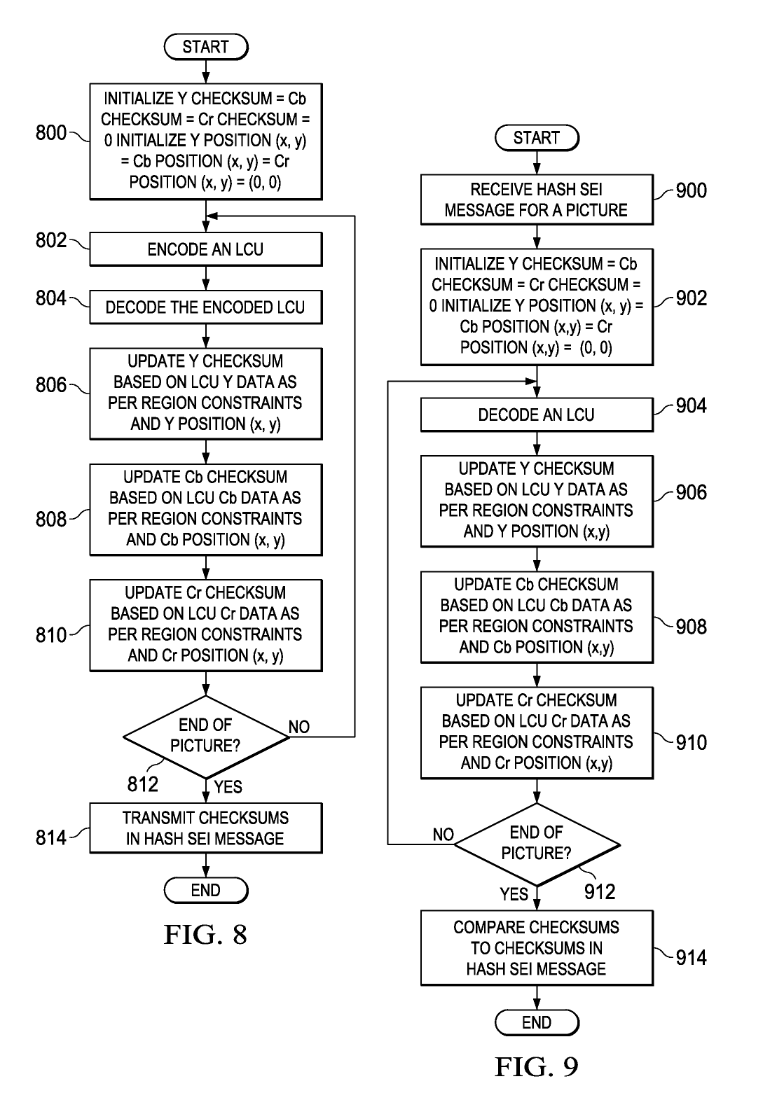

FIGS. 8, 9, and 10 are flow diagrams for, respectively, a method for checksum computation and hash SEI message generation for a picture that may be performed in a video encoder, e.g., the video encoder of FIGS. 4A and 4B, a method for hash SEI message decoding and checksum computation for a picture that may be performed in a video decoder, e.g., the video decoder of FIGS. 5A and 5B and a method for LCU-based checksum computation for a color component used by the methods of FIGS. 8 and 9. In contrast to the methods of FIGS. 5 and 6, which compute checksums for color components after a picture is decoded (including application of any enabled in-loop filters), the methods of FIGS. 8 and 9 compute checksums for each color component of a picture as the picture is being decoded. More specifically, these methods use an LCU-based method for color component checksum computation in which after each LCU is decoded, the color component checksums for the picture are updated based on a checksum computation region corresponding to the position of the LCU in the picture. More specifically, the color component checksums are updated based on checksum computation blocks for each color component corresponding to the LCU.

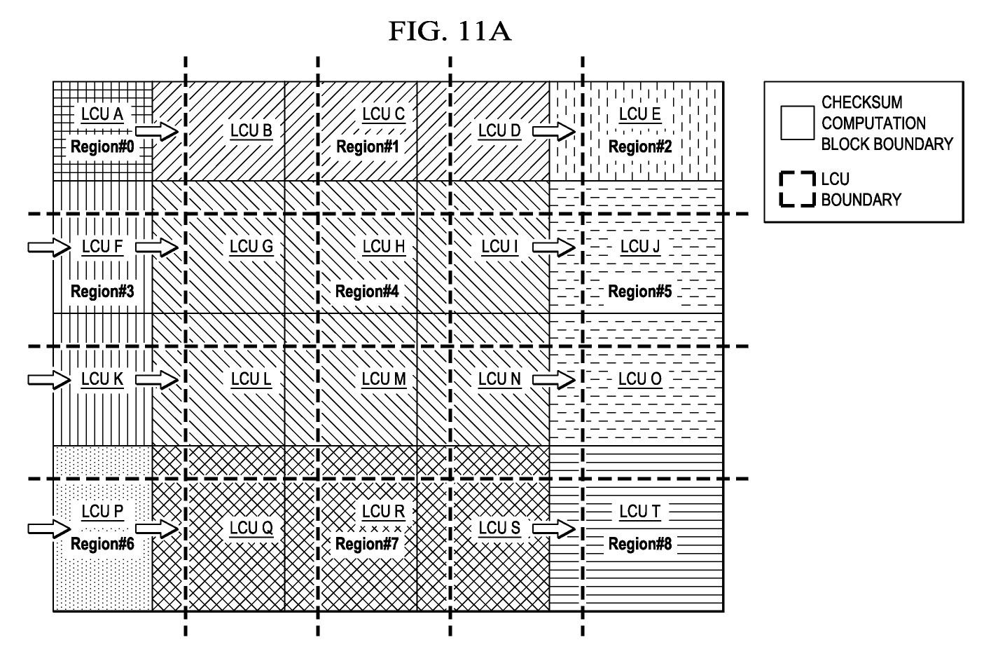

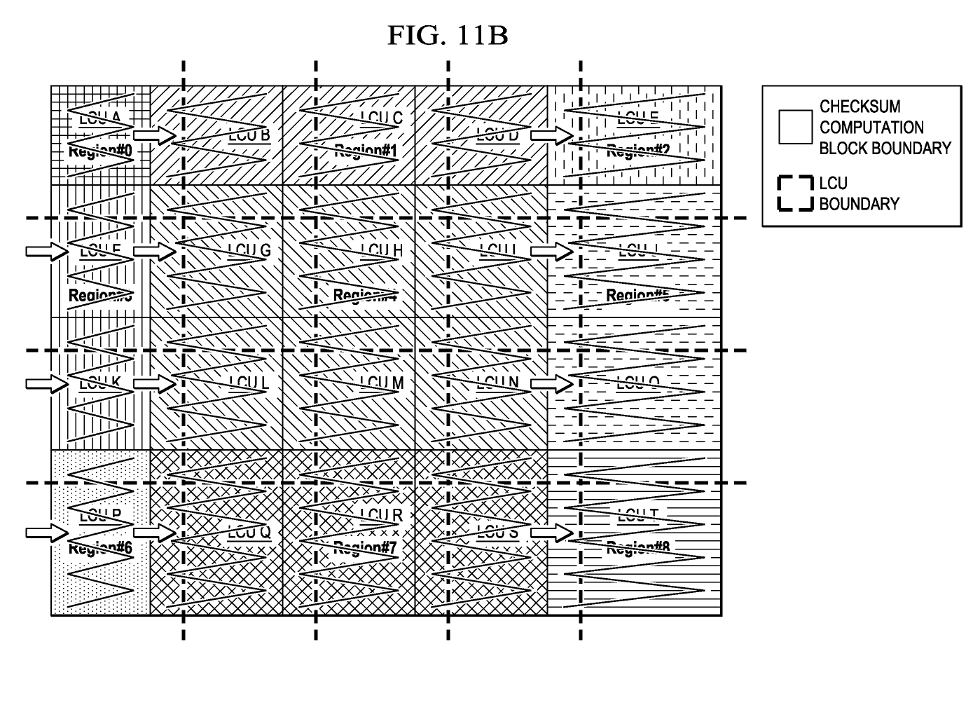

The checksum computation regions and checksum computation blocks are first explained reference to the example of FIGS. 11A and 11B. This simple example assumes a picture size of 256×256 and an LCU size of 64×64, resulting in 20 LCUs for the picture. In FIGS. 11A and 11B, the LCU boundaries are denoted by the dotted lines. The checksums for a picture are computed only on fully filtered (if enabled) decoded pixels. The in-loop filtering applied to a decoded LCU, e.g., deblocking, ALF (if present), and/or SAO, may need information from neighboring LCUs that have not yet been decoded. Specifically, a filtering delay may be incurred for columns on the right and/or rows on the bottom of some LCUs. For example, for LCU A, there may be a filtering delay for some number of rightmost columns in the LCU as data is needed from LCU B to complete the filtering of the pixels in those columns. Similarly, there may be a filtering delay for some number of bottom rows of LCU A as data is needed from LCU F to complete the filtering of the pixels in those rows. The number of rows/columns of delay depends on the implementation of the in-loop filters and which ones are applied. For purposes of the example, a filtering delay of four columns/rows is assumed.

For purposes of checksum computation, a picture is divided into nine checksum computation regions according to availability of fully filtered pixels for each decoded LCU. The size of each of these regions in a picture depends on the picture size, LCU size, color component, and the filtering delay. In this example, the nine regions are depicted by the different “shaded” areas in FIGS. 9A and 9B. The picture is then further divided into checksum computation blocks, one for each LCU. The boundaries for the checksum computation blocks for each LCU of the example are depicted by solid lines in FIGS. 11A and 11B. The checksum computation block for an LCU includes the fully filtered pixels of the LCU that are available at the time the LCU is decoded and, as appropriate, any fully filtered pixels from left and/or top neighboring LCUs that were not previously included in checksum computations because the current LCU was not yet decoded. For example, for LCU H, the checksum computation block includes the fully filtered pixels of LCU H, fully filtered pixels from the delayed right columns of LCU G (except for the pixels that depend on LCUs L and M), and fully filtered pixels from the delayed bottom rows of LCUs B and C (except for the pixels that depend on LCUs D and I).

Note that each checksum computation region includes one or more checksum computation blocks, and for regions with multiple checksum computation blocks, each of the blocks in a region is the same size. The size of a checksum computation block depends on picture size, LCU size, color component, and the filtering delay. Table 3 shows how the dimensions of a checksum computation block in each region are determined, where Lcu_height and Lcu_width are the LCU height and width, k is the filtering delay, LastColWidth is determined as per

WidthModLcuSz=((floor)(Width+Lcu_width−1/Lcu_width))

LastColWidth=Width−(WidthModLcuSz−1)*Lcu_width+k,

where Width is the picture width, LastRowHeight is determined as per

HeightModLcuSz=((floor)(Height+Lcu_height−1/Lcu_height))

LastRowHeight=Height−(HeightModLcuSz−1)*Lcu_height+k,

where Height is the picture height. Note that Lcu_height, Lcu_width, Width, and Height for the Cb and Or color components may be different from that of the Y color component. Also note that the way in which the dimensions are determined allows for cases in which the picture and LCU dimensions are such that the picture cannot be evenly divided into LCUs of the specific size. Table 4 shows an example of checksum computation block dimensions for each region for the Y color component of a 176×144 video sequence assuming k=1 and an LCU size of 64×64.

The value of k depends on the particular in-loop filtering toolset in use and the particular color component. For HEVC in-loop filtering as defined in HEVC Draft 6 and as implemented in the corresponding test model software, k may range from 0 to 9 depending on the color component and the combination of filtering tools used. Table 5 shows the value of k for no filtering or use of each filter alone. The value of k for using combinations of the filter tools may be derived from this table. For example, if the deblocking filter and ALF are enabled, but SAO is not, the value of k for the Y color component is 8 and for the Cb and Or color components is 6.

TABLE 3

| Region | | |
|---|---|---|
| number | Height | Width |
| 0 | Lcu_height - k | Lcu_width - k |
| 1 | Lcu_height - k | Lcu_width |
| 2 | Lcu_height - k | LastColWidth |
| 3 | Lcu_height | Lcu_width - k |
| 4 | Lcu_height | Lcu_width |
| 5 | Lcu_height | LastColWidth |
| 6 | LastRowHeight | Lcu_width - k |
| 7 | LastRowHeight | Lcu_width |
| 8 | LastRowHeight | LastColWidth |

TABLE 4

| Region | | |
|---|---|---|
| number | Height | Width |
| 0 | 63 | 63 |
| 1 | 63 | 64 |
| 2 | 63 | 49 |
| 3 | 64 | 63 |
| 4 | 64 | 64 |
| 5 | 64 | 49 |
| 6 | 17 | 63 |
| 7 | 17 | 64 |
| 8 | 17 | 49 |

TABLE 5

| Filtering Process | Y | Cb, Cr |
|---|---|---|
| No Inloop de-blocking | 0 | 0 |
| Only De-blocking filter | 4 | 2 |
| Only SAO filter | 1 | 1 |
| Only ALF | 4 | 4 |

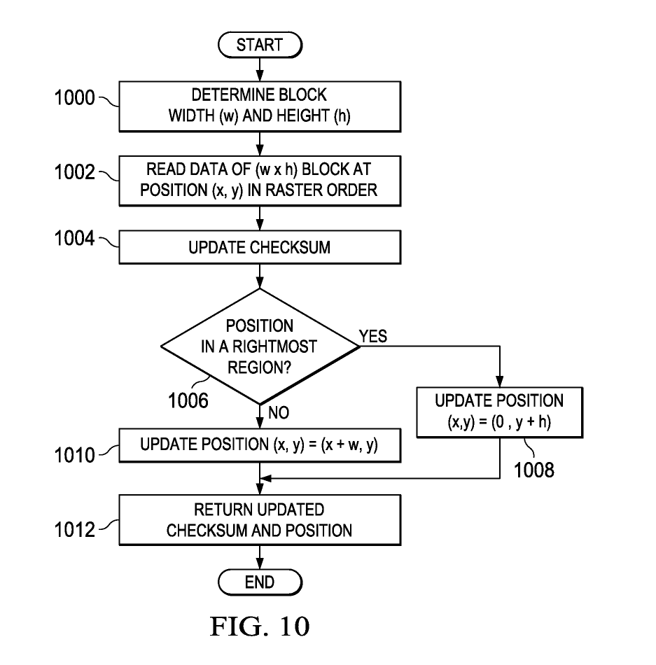

Referring now to the method of FIG. 8, initially the checksum and checksum computation block position (x,y) for each color component is initialized 800 to 0 and (0,0), respectively. For each LCU of the picture 812, the LCU is encoded 802 into the compressed video bit stream and is then reconstructed (decoded) 804. At this point, the pixels in the decoded LCU may not be fully processed by any enabled in-loop filtering. The checksums for each color component are then updated 806, 808, 810 for each color component based on the checksum computation region corresponding to the LCU. Updating of a checksum for a color component is performed as per the method of FIG. 10. Note that the method of FIG. 10 returns both an updated checksum and an updated position for a color component. Also note that because the checksums are computed separately for each color component, these computations may be performed in parallel in some embodiments. After all LCUs in the picture are processed 812 (in raster scan order), the computed checksums for the picture are transmitted 814 in the compressed bit stream in a hash SEI message corresponding to the picture. Table 2 shows example syntax for a hash SEI message conveying the three separate checksums.

Referring now to the method of FIG. 9, a hash SEI message for a picture is received 900. The checksum algorithm to be used and the color component checksums computed by the encoder for the picture are determined from this message. The checksum and checksum computation block position (x,y) for each color component is also initialized 902 to 0 and (0,0), respectively. For each LCU of the picture 912, the LCU is decoded 904 from the compressed video bit stream. At this point, the pixels in the decoded LCU may not be fully processed by any enabled in-loop filtering. The checksums for each color component are then updated 906, 908, 910 for each color component based on the checksum computation region corresponding to the LCU. Updating of a checksum for a color component is performed as per the method of FIG. 10. Note that the method of FIG. 10 returns both an updated checksum and an updated position for a color component. Also note that because the checksums are computed separately for each color component, these computations may be performed in parallel in some embodiments. After all LCUs in the picture are processed 912, the computed checksums are then compared 914 to the corresponding checksums from the hash SEI message. If the checksums are the same, normal processing continues. Actions taken if checksums are not the same are application dependent. For example, for an error prone transmission network, loss of bits or packets may be assumed and an error concealment process initiated. In another example, in video surveillance, camera tampering may be assumed and a security alert signaled.

As previously mentioned, FIG. 10 is a flow diagram of a method for checksum computation for a color component that is used by the methods of FIGS. 8 and 9. This method is performed after each LCU of a picture is decoded and is performed separately for each of the three color components Y, Cb, and Cr. This method assumes that the checksum algorithm to be used has been previously selected. The method receives the previously updated checksum value and the current checksum computation block position (x,y) for a color component as input.

Initially, the width and height of the checksum computation block corresponding to the current LCU are determined 1000. This determination is based on the particular checksum computation region of the LCU. Determining of the dimensions of a checksum computation block for a given checksum computation region and color component is previously described herein. The color component data for pixels in the checksum computation block is then read 1002 in raster scan order (see FIG. 11B) and the checksum is updated 104 based on this data. The checksum computation block position (x,y) is then updated for the next LCU. If the current block position is in a rightmost checksum computation region of the picture 1006, e.g., regions 2 and 5 of FIG. 11A, the block position is updated 1008 to begin with the next row of checksum computation blocks. Otherwise, the block position is updated 1012 to the next block position in the current row. The updated checksum and the block position are then returned 1012.

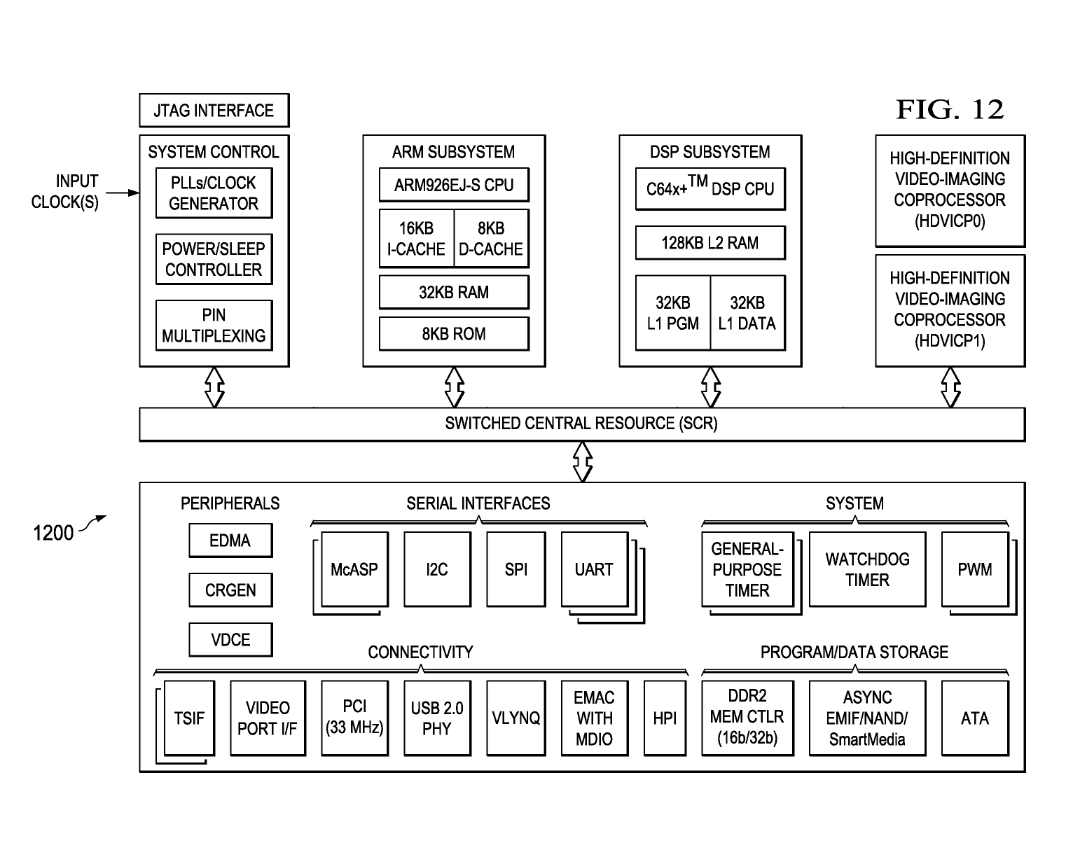

Embodiments of the methods, encoders, and decoders described herein may be implemented for virtually any type of digital system (e.g., a desk top computer, a laptop computer, a tablet computing device, a netbook computer, a handheld device such as a mobile (i.e., cellular) phone, a personal digital assistant, a digital camera, etc.). FIG. 12 is a block diagram of an example digital system suitable for use as an embedded system that may be configured to perform an embodiment of a method for checksum computation and hash SEI message generation as described herein during encoding of a video stream and/or to perform an embodiment of a method for checksum computation and hash SEI message decoding as described herein during decoding of a compressed video bit stream. This example system-on-a-chip (SoC) is representative of one of a family of DaVinci™ Digital Media Processors, available from Texas Instruments, Inc. This SoC is described in more detail in “TMS320DM6467 Digital Media System-on-Chip”, SPRS403G, December 2007 or later, which is incorporated by reference herein.

The SoC 1200 is a programmable platform designed to meet the processing needs of applications such as video encode/decode/transcode/transrate, video surveillance, video conferencing, set-top box, medical imaging, media server, gaming, digital signage, etc. The SoC 1200 provides support for multiple operating systems, multiple user interfaces, and high processing performance through the flexibility of a fully integrated mixed processor solution. The device combines multiple processing cores with shared memory for programmable video and audio processing with a highly-integrated peripheral set on common integrated substrate.

The dual-core architecture of the SoC 1200 provides benefits of both DSP and Reduced Instruction Set Computer (RISC) technologies, incorporating a DSP core and an ARM926EJ-S core. The ARM926EJ-S is a 32-bit RISC processor core that performs 32-bit or 16-bit instructions and processes 32-bit, 16-bit, or 8-bit data. The DSP core is a TMS320C64x+TM core with a very-long-instruction-word (VLIW) architecture. In general, the ARM is responsible for configuration and control of the SoC 1200, including the DSP Subsystem, the video data conversion engine (VDCE), and a majority of the peripherals and external memories. The switched central resource (SCR) is an interconnect system that provides low-latency connectivity between master peripherals and slave peripherals. The SCR is the decoding, routing, and arbitration logic that enables the connection between multiple masters and slaves that are connected to it.

The SoC 1200 also includes application-specific hardware logic, on-chip memory, and additional on-chip peripherals. The peripheral set includes: a configurable video port (Video Port I/F), an Ethernet MAC (EMAC) with a Management Data Input/Output (MDIO) module, a 4-bit transfer/4-bit receive VLYNQ interface, an inter-integrated circuit (I2C) bus interface, multichannel audio serial ports (McASP), general-purpose timers, a watchdog timer, a configurable host port interface (HPI); general-purpose input/output (GPIO) with programmable interrupt/event generation modes, multiplexed with other peripherals, UART interfaces with modem interface signals, pulse width modulators (PWM), an ATA interface, a peripheral component interface (PCI), and external memory interfaces (EMIFA, DDR2). The video port I/F is a receiver and transmitter of video data with two input channels and two output channels that may be configured for standard definition television (SDTV) video data, high definition television (HDTV) video data, and raw video data capture.

As shown in FIG. 12, the SoC 1200 includes two high-definition video/imaging coprocessors (HDVICP) and a video data conversion engine (VDCE) to offload many video and image processing tasks from the DSP core. The VDCE supports video frame resizing, anti-aliasing, chrominance signal format conversion, edge padding, color blending, etc. The HDVICP coprocessors are designed to perform computational operations required for video encoding such as motion estimation, motion compensation, intra-prediction, transformation, quantization, and in-loop filtering. Further, the distinct circuitry in the HDVICP coprocessors that may be used for specific computation operations is designed to operate in a pipeline fashion under the control of the ARM subsystem and/or the DSP subsystem.

As was previously mentioned, the SoC 1200 may be configured to perform embodiments of methods described herein during encoding of a video stream and/or during decoding of a compressed video bit stream. For example, the coding control of the video encoder of FIGS. 3A and 3B may be executed on the DSP subsystem or the ARM subsystem and at least some of the computational operations of the block processing, including the intra-prediction and inter-prediction of mode selection, transformation, quantization, and entropy encoding may be executed on the HDVICP coprocessors. Similarly, the decoding control of the video decoder of FIGS. 4A and 4B may be executed on the DSP subsystem or the ARM subsystem and at least some of the computational operations of the various components of the video decoder, including entropy decoding, inverse quantization, inverse transformation, intra-prediction, and motion compensation may be executed on the HDVICP coprocessors.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments have been described herein in which the particular checksum algorithms used for checksum computation are those defined by HEVC. One of ordinary skill in the art will understand that the particular checksum algorithms used are defined by the video coding standard in use. Thus, one of ordinary skill in the art will understand that more or fewer checksum algorithms than those described herein and/or different suitable checksum algorithms may be used in embodiments of the invention.

In another example, embodiments have been described herein in which the color space of a picture is assumed to be YCbCr. One of ordinary skill in the art will understand embodiments for different color spaces, e.g., RGB.

Embodiments of the methods, encoders, and decoders described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

It is therefore contemplated that the appended claims will cover any such modifications of the embodiments as fall within the true scope of the invention.

What is claimed is:

1. A method comprising:
decoding an encoded picture; and
computing a checksum for each of a Y color component, a Cb color component, and a Cr color component of the decoded picture.

2. The method of claim 1, further comprising:
transmitting the computed checksums for the picture in a supplemental enhancement information (SEI) message corresponding to the picture.

3. The method of claim 1, further comprising:
receiving a supplemental enhancement information (SEI) message corresponding to the picture, wherein the SEI message comprises a checksum for each of the Y color component, the Cb color component, and the Cr color component of the picture computed by an encoder; and
comparing the received checksums to the computed checksums.

4. The method of claim 1, wherein computing a checksum comprises computing each checksum after the decoding is complete and in-loop filtering is applied to the decoded picture.

5. The method of claim 1, wherein computing a checksum comprises computing the checksums in parallel.

6. The method of claim 1, wherein
decoding an encoded picture comprises decoding largest coding units (LCUs) of the picture on an LCU by LCU basis; and
computing a checksum comprises updating the checksum for each of the Y color component, the Cb color component, and the Cr color component on an LCU by LCU basis.

7. The method of claim 6, wherein computing a checksum further comprises:
determining dimensions of a first checksum computation block corresponding to an LCU for the Y color component of the LCU;
updating the checksum for the Y color component based on Y color component data in the checksum computation block;
determining dimensions of a second checksum computation block corresponding to the LCU for the Cb and Or color components of the LCU;
updating the checksum for the Cb color component based on Cb color component data in the second checksum computation block; and
updating the checksum for the Or color component based on Or color component data in the second checksum computation block.

8. The method of claim 7, wherein dimensions of the first checksum computation block and the second checksum computation block are determined based on a checksum computation region of the picture corresponding to the LCU.

9. An apparatus comprising:
means for decoding an encoded picture; and
means for computing a checksum for each of a Y color component, a Cb color component, and a Or color component of the decoded picture.

10. The apparatus of claim 9, further comprising:
means for transmitting the computed checksums for the picture in a supplemental enhancement information (SEI) message corresponding to the picture.

11. The apparatus of claim 9, further comprising:
means for receiving a supplemental enhancement information (SEI) message corresponding to the picture, wherein the SEI message comprises a checksum for each of the Y color component, the Cb color component, and the Or color component of the picture computed by an encoder; and
means for comparing the received checksums to the computed checksums.

12. The apparatus of claim 9, wherein the means for computing a checksum computes each checksum after the decoding is complete and in-loop filtering is applied to the decoded picture.

13. The apparatus of claim 9, wherein the means for computing a checksum computes the checksums in parallel.

14. The apparatus of claim 9, wherein
the means for decoding an encoded picture decodes largest coding units (LCUs) of the picture on an LCU by LCU basis; and
the means for computing a checksum updates the checksum for each of the Y color component, the Cb color component, and the Or color component on an LCU by LCU basis.

15. The apparatus of claim 14, wherein the means for computing a checksum further comprises:
means for determining dimensions of a first checksum computation block corresponding to an LCU for the Y color component of the LCU;
means for updating the checksum for the Y color component based on Y color component data in the checksum computation block;
means for determining dimensions of a second checksum computation block corresponding to the LCU for the Cb and Or color components of the LCU;
means for updating the checksum for the Cb color component based on Cb color component data in the second checksum computation block; and
means for updating the checksum for the Or color component based on Or color component data in the second checksum computation block.

16. The apparatus of claim 15, wherein dimensions of the first checksum computation block and the second checksum computation block are determined based on a checksum computation region of the picture corresponding to the LCU.

17. A non-transitory computer readable medium storing software instructions that, when executed by a processor, cause a method to be performed, the method comprising:
decoding an encoded picture; and
computing a checksum for each of a Y color component, a Cb color component, and a Cr color component of the decoded picture.

18. The non-transitory computer readable medium of claim 17, wherein the method further comprises:
transmitting the computed checksums for the picture in a supplemental enhancement information (SEI) message corresponding to the picture.

19. The non-transitory computer readable medium of claim 17, wherein the method further comprises:
receiving a supplemental enhancement information (SEI) message corresponding to the picture, wherein the SEI message comprises a checksum for each of the Y color component, the Cb color component, and the Cr color component of the picture computed by an encoder; and
comparing the received checksums to the computed checksums.

20. The non-transitory computer readable medium of claim 17, wherein computing a checksum comprises computing the checksums in parallel.
